(19) United States
(12) Patent Application Publication
(10) Pub. No.: US 2013/0008473 A1
(43) Pub. Date: Jan. 10, 2013

(54) ULTRASONIC CLEANING APPARATUS AND ULTRASONIC CLEANING METHOD

(76) Inventors: Toru Tuziuti, Nagoya-shi (JP); Yasuo Iida, Nagoya-shi (JP); Kyuichi Yasui, Nagoya-shi (JP); Yasuhiro Imazeki, Hamura-shi (JP); Hiroshi Hasegawa, Hamura-shi (JP)

(21) Appl. No.: 13/582,118

(22) PCT Filed: Jun. 2, 2011
(86) PCT No.: PCT/JP2011/063195

§ 371 Date: Aug. 31, 2012

(30) Foreign Application Priority Data
Jun. 7, 2010 (JP) 2010-130211

(51) Int. Cl. B08B 3/12

(52) U.S. Cl. 134/34; 134/184

(57) ABSTRACT

To provide an ultrasonic cleaning apparatus and an ultrasonic cleaning method capable of suppressing generation of cleaning unevenness after the ultrasonic cleaning of an object to be cleaned. An aspect of the present invention includes a cleaning tank 21 in which a cleaning liquid 23 is stored; a first and a second ultrasonic transducers 34a and 34b that give ultrasonic vibrations to the object to be cleaned 22 immersed in a cleaning liquid within the cleaning tank; a first ultrasonic generator 36 that applies a high-frequency output to the first ultrasonic transducer; a second ultrasonic generator 37 that applies a high-frequency output to the second ultrasonic transducer; and a controller 38 that varies and controls at least one of the outputs of the first and the second ultrasonic generators, and a first ultrasonic wave oscillated from the first ultrasonic transducer is caused to interfere with a second ultrasonic wave oscillated from the second ultrasonic transducer.

### TECHNICAL FIELD

The present invention relates to an ultrasonic cleaning apparatus and ultrasonic cleaning method, which perform ultrasonic cleaning on an object to be cleaned, etc.

### BACKGROUND ART

FIG. 8 is a cross-sectional view showing a conventional ultrasonic cleaning tank.

The ultrasonic cleaning tank has a wafer 1 that is an object to be cleaned, a cleaning basket 2, a cleaning liquid 3, a cleaning tank 4 made up of quartz, a guide 5 for positioning the cleaning basket 2, an ultrasonic radiation plate 6, an ultrasonic transducer 7 attached to the radiation plate 6, a medium 8 that transmits ultrasonic wave from the radiation plate 6 to the cleaning tank 4, and a supporting part 11 of the wafer 1, which is provided for the cleaning basket 2 (for example, see Patent Document 1).

In the above-mentioned conventional ultrasonic cleaning tank, the ultrasonic wave is reflected by the supporting part 11 of the wafer 1 and is attenuated, and, therefore, the transmission ratio of the ultrasonic wave toward the upper part of the supporting part 11 becomes small. Accordingly, a shadow 13 of the supporting part 11 appears on the wafer 1. The shadow 13 is a shadow caused because the ultrasonic wave has not been transmitted to the wafer 1 due to the supporting part 11. And, since the ultrasonic wave is sufficiently transmitted to the central part of the wafer 1, a significant difference in cleaning results is generated between the central part of the wafer 1 and the shadow 13 of the supporting part. Consequently, when trying to obtain sufficiently a cleaning effect in the shadow 13 of the supporting part, the cleaning requires a long time and a damage occurs easily in parts of the wafer 1 where the ultrasonic wave is transmitted easily.

FIG. 9 is a schematic view showing a conventional ultrasonic cleaning apparatus.

The ultrasonic cleaning apparatus includes a cleaning tank 15 filled with a cleaning liquid 4 for cleaning an object to be cleaned W, two ultrasonic transducers 111 and 112 that cause ultrasonic oscillations to transmit to the cleaning liquid, and ultrasonic generators 16 and 17 that apply high-frequency voltages to these ultrasonic transducers. Each of two ultrasonic transducers 111 and 112 is attached to radiation plates 19a and 19b. The ultrasonic cleaning apparatus cleans an object to be cleaned by sweeping the frequency of at least one ultrasonic transducer of two ultrasonic transducers to move a cavitation region generated in the cleaning liquid (for example, see Patent Document 2).

In the conventional ultrasonic cleaning apparatus, since there is a limit in order to sweep the frequency of the ultrasonic transducer and the sweeping can only be performed in a limited frequency region, the range of movable cavitation region is also a limited one. In addition, the oscillation is performed at frequencies separated from a resonance frequency, which generates an acoustic pressure drop and leads to the drop of cleaning effect. Furthermore, the acoustic pressure drop differs in the degree thereof depending on the frequency or oscillation element, which makes the control difficult.

### RELATED TECHNICAL DOCUMENTS

### Patent Documents

Patent Document 1: J Japanese Patent Application Laid-Open Publication No. 04-49619 (FIG. 4)

Patent Document 2: Japanese Patent Application Laid-Open Publication No. 2009-125645 (Abstract, FIG. 1)

### DISCLOSURE OF THE INVENTION

### Problems that the Invention is to Solve

An aspect of the present invention is to provide an ultrasonic cleaning apparatus and an ultrasonic cleaning method capable of suppressing generation of cleaning unevenness after the ultrasonic cleaning of an object to be cleaned.

### Means for Solving the Problems

An aspect of the present invention is an ultrasonic cleaning apparatus, including:

a cleaning tank in which a cleaning liquid is stored;

a first and a second ultrasonic transducers that give ultrasonic vibrations to an object to be cleaned immersed in the cleaning liquid within the cleaning tank;

a first ultrasonic generator that applies a high-frequency output to the first ultrasonic transducer;

a second ultrasonic generator that applies a high-frequency output to the second ultrasonic transducer; and

a controller that varies and controls at least one of the outputs of the first and the second ultrasonic generators, and

a first ultrasonic wave oscillated from the first ultrasonic transducer is caused to interfere with a second ultrasonic wave oscillated from the second ultrasonic transducer.

It should be noted that the interference also includes oblique interference.

An aspect of the present invention is an ultrasonic cleaning apparatus, including:

a cleaning tank in which a cleaning liquid is stored;

a plurality of ultrasonic transducers that gives ultrasonic vibrations to an object to be cleaned immersed in the cleaning liquid within the cleaning tank;

a plurality of ultrasonic generators that applies high-frequency outputs to each of the plurality of ultrasonic transducers; and

a controller that varies and controls outputs of one or more ultrasonic generators among the plurality of ultrasonic generators, and

an ultrasonic wave oscillated from the ultrasonic transducer to which a high-frequency output is applied by the one or more ultrasonic generators is caused to interfere with an ultrasonic wave oscillated from an ultrasonic transducer to which a high-frequency output is applied by at least one ultrasonic generator among the plurality of ultrasonic generators.

Further, in an aspect of the present invention,

variation of the output of the one or more ultrasonic generators can also be any of an output variation that increases the output continuously from an output not less than 0% to an output not more than 100%, an output variation that increases the output stepwise from an output not less than 0% to an output not more than 100%, an output variation that decreases the output continuously from an output not more than 100% to an output not less than 0%, an output variation that decreases the output stepwise from an output not more than 100% to an output not less than 0%, an output variation that increases the output instantaneously from an output more than 0% to an output less than 100% and an output variation that decreases the output instantaneously from an output less than 100% to an output more than 0%, or a plurality of output variations among these.

Furthermore, in an aspect of the present invention, the object to be cleaned may be one object to be cleaned, or a plurality of objects to be cleaned.

An aspect of the present invention is an ultrasonic cleaning method, including the steps of:

immersing an object to be cleaned in a cleaning liquid within a cleaning tank; and

cleaning the object to be cleaned by giving an ultrasonic vibration to the object to be cleaned by a first ultrasonic transducer and, simultaneously, giving an ultrasonic vibration to the object to be cleaned by a second ultrasonic transducer, and

along with the interference of a first ultrasonic wave oscillated from the first ultrasonic transducer with a second ultrasonic wave oscillated from the second ultrasonic transducer, a high-frequency output applied to at least one of the first and the second ultrasonic transducers is varied.

An aspect of the present invention is an ultrasonic cleaning method, including the steps of:

immersing an object to be cleaned in a cleaning liquid within a cleaning tank; and

cleaning the object to be cleaned by giving an ultrasonic vibration by a plurality of ultrasonic transducers, and

along with the interference of an ultrasonic wave oscillated from one or more ultrasonic transducers among the plurality of ultrasonic transducers, with an ultrasonic wave oscillated from at least one ultrasonic transducer among the plurality of ultrasonic transducers, a high-frequency output applied to the one or more ultrasonic transducers is varied.

### Advantage of the Invention

According to an aspect of the present invention, it is possible to provide an ultrasonic cleaning apparatus and an ultrasonic cleaning method capable of suppressing generation of cleaning unevenness after the ultrasonic cleaning of an object to be cleaned.

### BRIEF DESCRIPTION OF THE DRAWINGS

FIG. 1 is a schematic view showing the configuration of an ultrasonic cleaning apparatus according to an aspect of the present invention.

FIGS. 2A to 2D are drawings showing specific examples of respective output controls of a first and a second ultrasonic generators 26 and 27 by a controller 28 shown in FIG. 1.

FIG. 3 is a schematic view showing the configuration of a cleaning tank according to a modified example of an aspect of the present invention.

FIG. 4A is a plan view showing schematically the configuration of an ultrasonic cleaning apparatus according to an aspect of the present invention, FIG. 4B is a cross-sectional view of the cleaning tank shown in FIG. 4A, and FIG. 4C is a perspective view of the cleaning tank shown in FIG. 4A.

FIG. 5 is a drawing showing a result of measuring an acoustic pressure in the cleaning tank by using the ultrasonic cleaning apparatus shown in FIG. 1.

FIG. 6 is a drawing showing a result of measuring a bubble distribution in the cleaning tank by using the ultrasonic cleaning apparatus shown in FIG. 1.

FIG. 7A is a drawing showing a result of measuring a distribution of fine particles after cleaning again the object to be cleaned, and FIG. 7B is a drawing showing a result of calculating particle removal efficiency from the measurement result shown in FIG. 7A.

FIG. 8 is a cross-sectional view showing a conventional ultrasonic cleaning tank.

FIG. 9 is a schematic view showing a conventional ultrasonic cleaning apparatus.

### BEST MODE FOR CARRYING OUT THE INVENTION

Hereinafter, embodiments of the present invention will be explained in detail by using the drawings. However, a person skilled in the art can understand easily that the present invention is not limited to the following explanation, but that aspects and details thereof may be changed variously without deviating from the purport and scope of the present invention. Accordingly, the present invention should not be construed with the restriction to the contents of embodiments shown below.

### First Embodiment

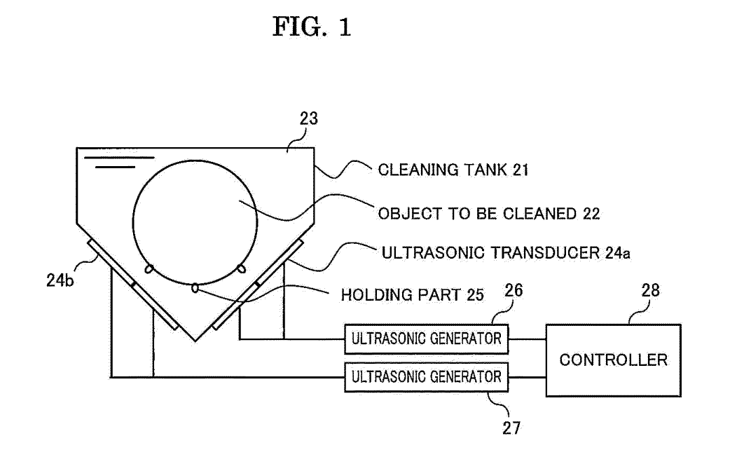

FIG. 1 is a schematic view showing the configuration of an ultrasonic cleaning apparatus according to an aspect of the present invention.

The ultrasonic cleaning apparatus has a cleaning tank 21 filled with a cleaning liquid 23, wherein the cleaning tank 21 is a batch-type process tank that cleans a plurality of objects to be cleaned 22 (for example, semiconductor wafers, compact discs, glass substrates, flat panel displays, thin discs or substrates, etc.). In the cleaning tank 21, a holding part 25 that holds the object to be cleaned 22 is disposed. The cleaning tank 21 has a V bottom with a V shape cross-section. To the bottom on one side of the V bottom, a right side ultrasonic transducer 24a (a first ultrasonic transducer) is attached, and, to the other side of the V bottom, a left side ultrasonic transducer 24b (a second ultrasonic transducer) is attached. This makes it possible to irradiate the object to be cleaned 22 with ultrasonic waves from two directions.

To the right side ultrasonic transducer 24a, a first ultrasonic generator 26 is electrically connected, and, to the left side ultrasonic transducer 24b, a second ultrasonic generator 27 is electrically connected. Each of the first and second ultrasonic generators 26 and 27 is one that applies a high-frequency output to each of the right side ultrasonic transducer 24a and the left side ultrasonic transducer 24b. To each of the first and the second ultrasonic generators 26 and 27, a controller 28 is electrically connected. The controller 28 is one that controls each output of the first and the second ultrasonic generators 26 and 27.

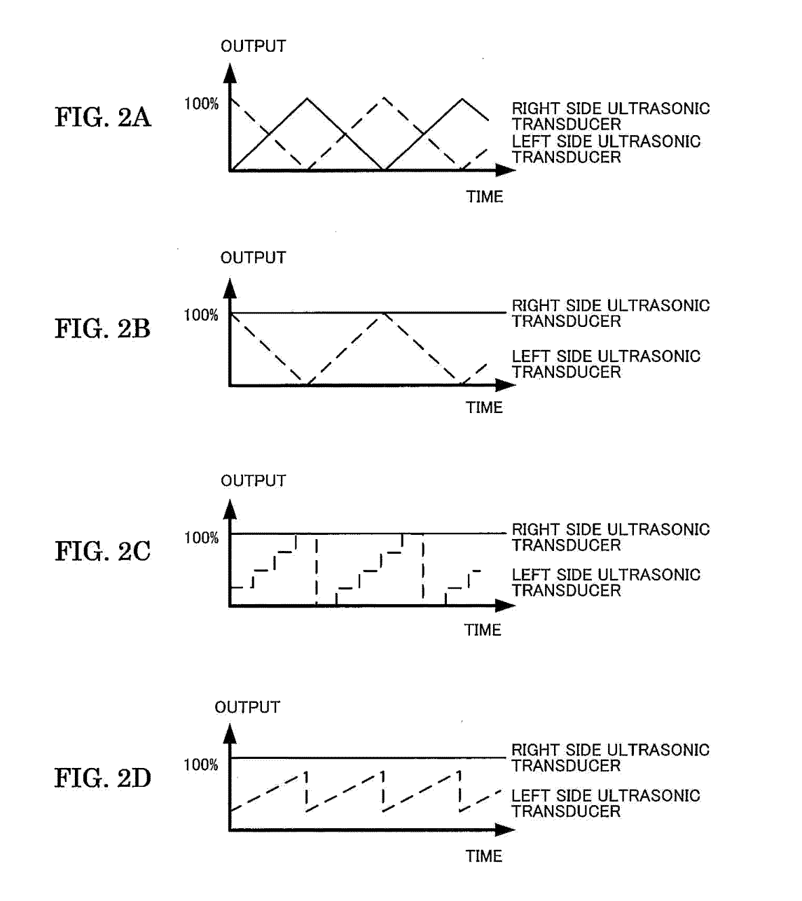

FIGS. 2A to 2D are drawings showing specific examples of respective output controls of the first and second ultrasonic generators 26 and 27 by the controller 28 shown in FIG. 1.

The output control shown in FIG. 2A is an output control in which the output applied to the right side ultrasonic transducer 24a by the first ultrasonic generator 26 is increased continuously from the output 0% to the output 100% and, simultaneously, the output applied to the left side ultrasonic transducer 24b by the second ultrasonic generator 27 is decreased continuously from the output 100% to the output 0%, and, after that, the output applied to the right side ultrasonic transducer 24a by the first ultrasonic generator 26 is decreased continuously from the output 100% to the output 0% and, simultaneously, the output applied to the left side ultrasonic transducer 24b by the second ultrasonic generator 27 is increased continuously from the output 0% to the output 100%, and after that these are repeated.

The output control shown in FIG. 2B is an output control in which the output applied to the right side ultrasonic transducer 24a by the first ultrasonic generator 26 is the output 100% and kept constant and the output applied to the left side ultrasonic transducer 24b by the second ultrasonic generator 27 is decreased continuously from the output 100% to the output 0%, and, after that, the output applied to the left side ultrasonic transducer 24b by the second ultrasonic generator 27 is increased continuously from the output 0% to the output 100%, and after that these are repeated. The output control shown in FIG. 2C is an output control in which the output applied to the right side ultrasonic transducer 24a by the first ultrasonic generator 26 is the output 100% and kept constant and the output applied to the left side ultrasonic transducer 24b by the second ultrasonic generator 27 is increased stepwise from the output 0% to the output 100%, and, after that, the output applied to the left side ultrasonic transducer 24b by the second ultrasonic generator 27 is decreased instantaneously from the output 100% to the output 0%, and after that these are repeated.

The output control shown in FIG. 2D is an output control in which the output applied to the right side ultrasonic transducer 24a by the first ultrasonic generator 26 is the output 100% and kept constant and the output applied to the left side ultrasonic transducer 24b by the second ultrasonic generator 27 is increased continuously from an output more than 0% to an output less than 100%, and, after that, the output applied to the left side ultrasonic transducer 24b by the second ultrasonic generator 27 is decreased instantaneously from an output less than 100% to an output more than 0%, and after that these are repeated.

Above-mentioned respective output controls of the first and the second ultrasonic generators 26 and 27 by the controller 28 are exemplifications, and other various output controls are possible, and following output controls other than the output control shown in FIG. 2 are also possible.

The output control of at least one of the first and the second ultrasonic generators 26 and 27 by the controller 28 is one by the variation of the output, which may be any of an output variation that increases the output continuously from an output not less than 0% to an output not more than 100%, an output variation that increases the output stepwise from an output not less than 0% to an output not more than 100%, an output variation that decreases the output continuously from an output not more than 100% to an output not less than 0%, an output variation that increases the output stepwise from an output not more than 100% to an output not less than 0%, an output variation that increases the output instantaneously from an output more than 0% to an output less than 100% and an output variation that decreases the output instantaneously from an output less than 100% to an output more than 0%, or a plurality of output variations.

Next, the ultrasonic cleaning method using the above-mentioned ultrasonic cleaning apparatus will be explained.

First, as shown FIG. 1, the object to be cleaned 22 is immersed within the cleaning liquid 23 in the cleaning tank 21. In more details, a plurality of objects to be cleaned 22 held by the holding part 25 are immersed in the cleaning tank 21 filled with the cleaning liquid 23.

Subsequently, while the first ultrasonic generator 26 applies a high-frequency output to the right side ultrasonic transducer 24a to give an ultrasonic vibration to the object to be cleaned 22 by the right side ultrasonic transducer 24a, the second ultrasonic generator 27 applies high-frequency output to the left side ultrasonic transducer 24b to thereby give an ultrasonic vibration to the object to be cleaned 22 by the left side ultrasonic transducer 24b. At this time, while a first ultrasonic wave oscillated from the right side ultrasonic transducer 24a is caused to interfere with second ultrasonic waves oscillated from the left side ultrasonic transducer 24b, a high-frequency output applied to at least one of the right side ultrasonic transducer 24a and the left side ultrasonic transducer 24b by the first and the second ultrasonic generators 26 and 27 is varied by the controller 28. The specific control method by the controller 28 may be any of output controls shown in FIGS. 2A to 2D, or may be various output controls as mentioned above. Therefore, the object to be cleaned 22 is subjected to the ultrasonic cleaning.

According to the ultrasonic cleaning method, while the first ultrasonic waves oscillated from the right side ultrasonic transducer 24a is caused to interfere with the second ultrasonic waves oscillated from the left side ultrasonic transducer 24b, the output of at least one of the right side ultrasonic transducer 24a and the left side ultrasonic transducer 24b is varied. Consequently, the ultrasonic wave formed by the interference of the first ultrasonic wave and the second ultrasonic wave is varied and the direction of sound flows by the ultrasonic is varied, thereby making it possible to move the flow of the cleaning liquid, air bubbles, ultrasonic waves and the like. As the result, the whole of the object to be cleaned 22 can be cleaned with good uniformity.

More detailed explanation will be given. When each of the outputs of the right side ultrasonic transducer 24a and the left side ultrasonic transducer 24b is not varied but is kept constant, even if the first ultrasonic wave interferes with the second ultrasonic wave and respective sound flows are pushed each other, the ultrasonic wave formed by the interference does not change. Therefore, flows of the cleaning liquid, air bubbles and the like become constant, and, depending on the structure of the cleaning tank, cleaning unevenness may appear. In contrast, when output of each of the right side ultrasonic transducer 24a and the left side ultrasonic transducer 24b is varied, the ultrasonic wave formed by the interference of the first ultrasonic wave with the second ultrasonic wave changes to vary the sound flow, and flows of the cleaning liquid, air bubbles and the like do not become constant and can be moved. As the result, it is possible to suppress cleaning unevenness appearing after subjecting the object to be cleaned to the ultrasonic cleaning.

It should be noted that, in the aspect, the object to be cleaned 22 is subjected to the ultrasonic cleaning by using two ultrasonic transducers 24a and 24b, but the number of ultrasonic transducers is not limited to two, but three or more ultrasonic transducers may be used and the object to be cleaned 22 may be subjected to the ultrasonic cleaning. For example, when ultrasonic vibrations are given to the object to be cleaned by using a plurality of ultrasonic transducers of three or more, it is preferable, along with the interference of ultrasonic waves oscillated from one or more ultrasonic transducers among the plurality of ultrasonic transducers, with ultrasonic waves oscillated from at least one ultrasonic transducer among the plurality of ultrasonic transducers, to vary the output of the one or more ultrasonic transducers.

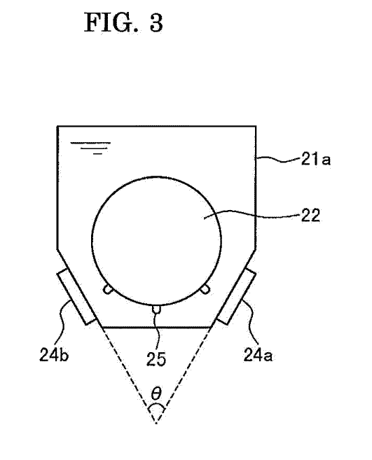

Furthermore, in the aspect, as shown in FIG. 1, the cleaning tank 21 having a cross-section of a V shape is used. However, the shape of the cleaning tank is not limited to the V shape, and a cleaning tank having another shape can be used only if it is a shape having an angle in the fitting surface of a plurality of ultrasonic transducers of the cleaning tank. For example, a cleaning tank 21a as shown in FIG. 3 can also be used, the cleaning tank 21a having a cross-section of a trapezoid shape and having an angle θ of more than 0° formed by fitting surfaces for right and left ultrasonic transducers 24a and 24b of the cleaning tank 21a.

### Second Embodiment

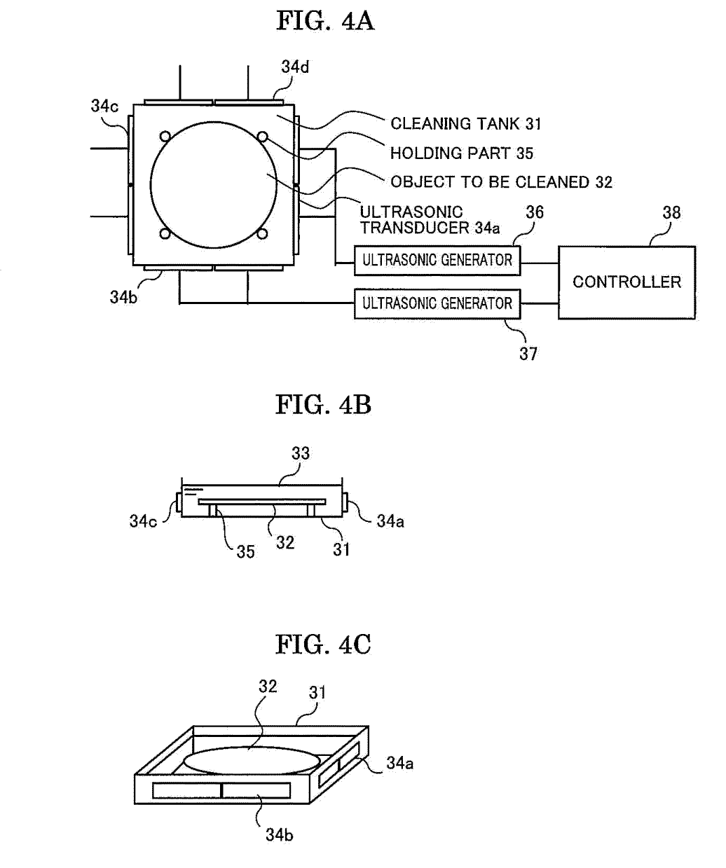

FIG. 4A is a plan view showing schematically the configuration of an ultrasonic cleaning apparatus according to an aspect of the present invention, FIG. 4B is a cross-sectional view showing the cleaning tank of the ultrasonic cleaning apparatus shown in FIG. 4A, and FIG. 4C is a perspective view of the cleaning tank shown in FIG. 4A.

The ultrasonic cleaning apparatus has a cleaning tank 31 filled with a cleaning liquid 33, and the cleaning tank 31 is a sheet-by-sheet process tank that cleans a sheet of object to be cleaned 32 (for example, a semiconductor wafer, a compact disc, a glass substrate, a flat panel display, a thin disc, a substrate or the like).

In the cleaning tank 31, a holding part 35 that holds the object to be cleaned 32 is disposed. The cleaning tank 31 has a planar face of a square shape, and, to four side surfaces of the cleaning tank 31, a first to a fourth ultrasonic transducers 34a to 34d are attached. Consequently, the object to be cleaned 32 can be irradiated with ultrasonic waves from four directions. It should be noted that, in the aspect, no ultrasonic transducer is attached to the bottom surface or the upper surface of the cleaning tank 31, but an ultrasonic transducer may also be attached to the bottom surface or the upper surface of the cleaning tank 31.

To the first ultrasonic transducer 34a, a first ultrasonic generator 36 is electrically connected, and, to the second ultrasonic transducer 34b, a second ultrasonic generator 37 is electrically connected. To a third ultrasonic transducer 34c, a third ultrasonic generator (not shown) is electrically connected, and, to a fourth ultrasonic transducer 34d, a fourth ultrasonic generator (not shown) is electrically connected. Each of the first to the fourth ultrasonic generators 36 to 37 is one that applies a high-frequency output to each of the first to the fourth ultrasonic transducers 34a to 34b. To each of the first to the fourth ultrasonic generators 36 to 37, a controller 38 is electrically connected. The controller 38 controls the output of each of the first to the fourth ultrasonic generators 36 to 37.

As to the output control of each of the first to the fourth ultrasonic generators 36 to 37 by the controller 38 shown in FIG. 4A, various output controls are possible, only if they can change the ultrasonic wave formed by the interference of an ultrasonic wave with an ultrasonic wave, can vary a sound flow, and can move flows of the cleaning liquid, air bubbles and the like. For example, along with the interference of the ultrasonic wave oscillated from one or more ultrasonic transducers among the first to the fourth ultrasonic transducers 34a to 34b, with the ultrasonic wave oscillated from at least one ultrasonic transducer among the first to the fourth ultrasonic transducers 34a to 34b, it is preferable to vary the output of the one or more ultrasonic transducers.

Variation of the output of the one or more ultrasonic transducers can be any of an output variation that increases the output continuously from an output not less than 0% to an output not more than 100%, an output variation that increases the output stepwise from an output not less than 0% to an output not more than 100%, an output variation that decreases the output continuously from an output not more than 100% to an output not less than 0%, an output variation that decreases the output stepwise from an output not more than 100% to an output not less than 0%, an output variation that increases the output instantaneously from an output more than 0% to an output less than 100% and an output variation that decreases the output instantaneously from an output less than 100% to an output more than 0%, or a plurality of output variations among these.

Next, the ultrasonic cleaning method using the above-mentioned ultrasonic cleaning apparatus will be explained.

First, as shown in FIG. 4, the object to be cleaned 32 is immersed in the cleaning liquid 33 within the cleaning tank 31. In more detail, one object to be cleaned 32 held by the holding part 35 is immersed within the cleaning tank 31 filled with the cleaning liquid 33.

Subsequently, from each of the first to the fourth ultrasonic generators, a high-frequency output is applied to the first to the fourth ultrasonic transducers, and, by each of the first to the fourth ultrasonic transducers, ultrasonic vibrations are given to the object to be cleaned 32. At this time, along with the interference of ultrasonic waves oscillated from one or more ultrasonic transducers among the first to the fourth ultrasonic transducers, with ultrasonic waves oscillated from at least one ultrasonic transducer among the first to the fourth ultrasonic transducers, the controller 38 varies the high-frequency output applied to the one or more ultrasonic transducers by the first to the fourth ultrasonic generators. The specific control method by the controller 38 may also be various output controls as mentioned above. Consequently, the object to be cleaned 32 is subjected to the ultrasonic cleaning.

According to the above ultrasonic cleaning method, as is the case with the first embodiment, it is possible to change the ultrasonic wave formed by the interference of an ultrasonic wave with an ultrasonic wave and to change the direction of the sound flow by the ultrasonic wave, thereby moving flows of the cleaning liquid, air bubbles, ultrasonic waves and the like. As the result, the whole of the object to be cleaned 32 can be cleaned with good uniformity.

A furthermore detail explanation will be given. When the output of each of the first to the fourth ultrasonic transducers is not varied but is kept constant, even if an ultrasonic wave interferes with an ultrasonic wave to thereby cause respective sound flows to push each other, flows of the cleaning liquid, air bubbles and the like become constant, and, depending on the structure of the cleaning tank, cleaning unevenness may appear. In contrast, when the output of one or more ultrasonic transducers among the first to the fourth ultrasonic transducers is varied, the ultrasonic wave formed by the interference of an ultrasonic wave with an ultrasonic wave changes and the sound flow changes, and flow of the cleaning liquid, air bubbles and the like does not become constant but can be moved. As the result, cleaning unevenness appearing after subjecting the object to be cleaned to the ultrasonic cleaning can be suppressed.

### EXAMPLES

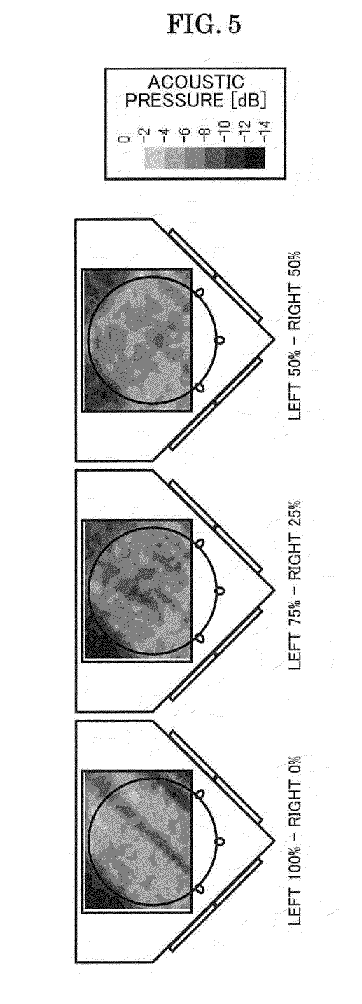

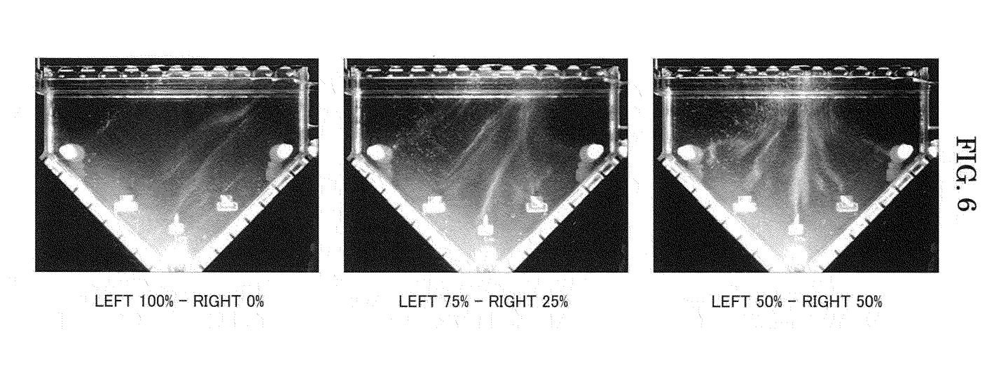

FIG. 5 is a drawing showing a result of measuring an acoustic pressure within the cleaning tank by using the ultrasonic cleaning apparatus shown in FIG. 1. FIG. 6 is a drawing showing a result of measuring a bubble distribution within the cleaning tank by using the ultrasonic cleaning apparatus shown in FIG. 1.

FIG. 5 shows the result of measuring the acoustic pressure when the output of the left side ultrasonic transducer 24b is set to be 100% and the output of the right side ultrasonic transducer 24a set to be 0%, the result of measuring the acoustic pressure when the output of the left side ultrasonic transducer 24b is set to be 75% and the output of the right side ultrasonic transducer 24a is set to be 25%, and the result of measuring the acoustic pressure when the output of the left side ultrasonic transducer 24b is set to be 50% and the output of the right side ultrasonic transducer 24a is set to be 50%. From these measurement results, it can be seen that the acoustic pressure within the cleaning tank is in a combined state of the ultrasonic wave from the left side ultrasonic transducer and the ultrasonic wave from the right side ultrasonic transducer.

FIG. 6 shows the bubble distribution when the output of the left side ultrasonic transducer 24b is set to be 100% and the output of the right side ultrasonic transducer 24a is set to be 0%, the bubble distribution when the output of the left side ultrasonic transducer 24b is set to be 75% and the output of the right side ultrasonic transducer 24a is set to be 25%, and the bubble distribution when the output of the left side ultrasonic transducer 24b is set to be 50% and the output of the right side ultrasonic transducer 24a is set to be 50%.

From these bubble distributions, it can be seen that the stagnation of air bubbles within the cleaning tank changes largely by changing the ultrasonic wave output of the left side ultrasonic transducer and the ultrasonic wave output of the right side ultrasonic transducer. That is, it was confirmed that the change of the output of right and left ultrasonic transducers makes it possible to operate the flow of air bubbles like a wiper and to move largely the stagnation position of air bubbles within the cleaning tank.

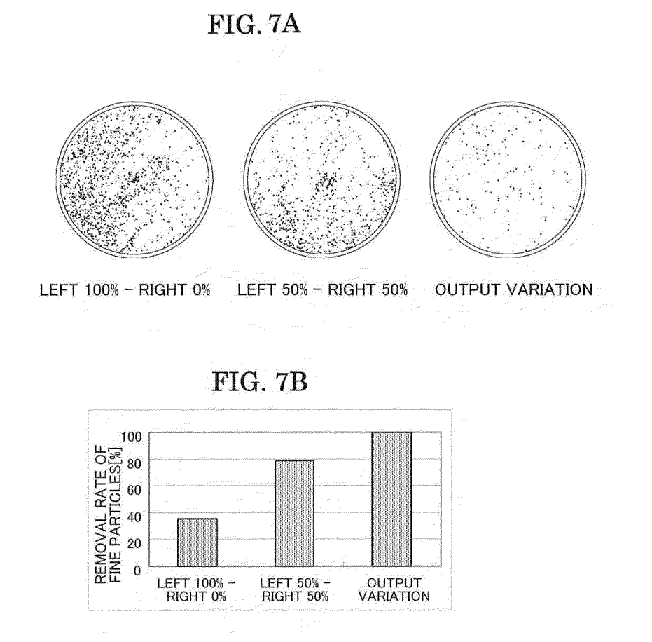

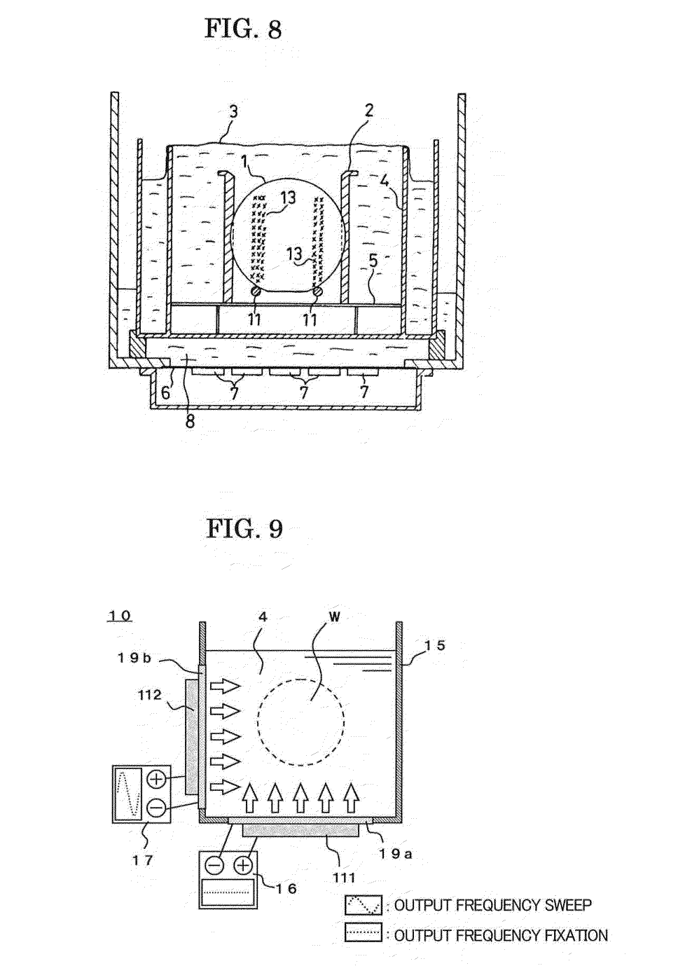

FIG. 7A is a drawing showing the result of measuring the distribution of fine particles after cleaning the object to be cleaned by the ultrasonic cleaning apparatus shown in FIG. 1. FIG. 7B is a drawing showing the result of calculating particle removal efficiency from the measurement result shown in FIG. 7A.

FIG. 7A shows the result of measuring the distribution of fine particles on the surface of the object to be cleaned after cleaning the object to be cleaned when the output of the left side ultrasonic transducer 24b is set to be 100% and the output of the right side ultrasonic transducer 24a is set to be 0% (hereinafter, referred to as “left 100%-right 0%”) , the result of measuring the distribution of fine particles on the surface of the object to be cleaned after cleaning the object to be cleaned when the output of the left side ultrasonic transducer 24b is set to be 50% and the output of the right side ultrasonic transducer 24a is set to be 50% (hereinafter, referred to as “left 50%-right 50%”), and the result of measuring the distribution of fine particles on the surface of the object to be cleaned after cleaning the object to be cleaned when the output of the left side ultrasonic transducer 24b and the output of the right side ultrasonic transducer 24a are varied as shown in FIG. 2A (hereinafter, referred to as “output variation”).

FIG. 7B shows the particle removal efficiency on the surface of the object to be cleaned shown in FIG. 7A. While the “output variation” exhibits a nearly 100% particle removal efficiency, the “left 100%-right 0%” and the “left 50%-right 50%” exhibit a lower particle removal efficiency. From these results, it was confirmed that the particle removal efficiency can be made higher in the case where outputs of the right and left ultrasonic transducers are varied, as compared with the case where outputs of the right and left ultrasonic transducers are kept constant.

As shown in FIGS. 7A and 7B, when outputs of the right and left ultrasonic transducers are kept constant, cleaning unevenness appears on the surface of the object to be cleaned, but, in contrast, when outputs of the right and left ultrasonic transducers are varied, it is possible to suppress cleaning unevenness appearing on the surface of the object to be cleaned and to clean, with good uniformity, the whole surface of the object to be cleaned.

### Description of Reference Numerals and Signs

1: wafer
2: cleaning basket
3: cleaning liquid
4: cleaning tank
5: guide for positioning
6: ultrasonic radiation plate
7: ultrasonic transducer
8: medium that transmits ultrasonic waves
11: supporting part
13: shadow of supporting part
16, 17: ultrasonic generator
19a, 19b: radiation plate
21, 21a, 31: cleaning tank
22, 32: object to be cleaned
23, 33: cleaning liquid
24a: right side ultrasonic transducer (first ultrasonic transducer)
24b: left side ultrasonic transducer (second ultrasonic transducer)
25, 35: holding part
26, 36: first ultrasonic generator
27, 37: second ultrasonic generator
28, 38: controller
34a: first ultrasonic transducer
34b: second ultrasonic transducer
34c: third ultrasonic transducer
34d: fourth ultrasonic transducer
111, 112: ultrasonic transducer

1. An ultrasonic cleaning apparatus, comprising:
a cleaning tank in which a cleaning liquid is stored;
a first and a second ultrasonic transducers that give ultrasonic vibrations to an object to be cleaned immersed in the cleaning liquid within said cleaning tank;
a first ultrasonic generator that applies a high-frequency output to said first ultrasonic transducer;
a second ultrasonic generator that applies a high-frequency output to said second ultrasonic transducer; and
a controller that varies and controls at least one of the outputs of said first and second ultrasonic generators, wherein
a first ultrasonic wave oscillated from said first ultrasonic transducer is caused to interfere with a second ultrasonic wave oscillated from said second ultrasonic transducer.

2. The apparatus according to claim 1, wherein
variation of said output is any of an output variation that increases the output continuously from an output not less than 0% to an output not more than 100%, an output variation that increases the output stepwise from an output not less than 0% to an output not more than 100%, an output variation that decreases the output continuously from an output not more than 100% to an output not less than 0%, an output variation that decreases the output stepwise from an output not more than 100% to an output not less than 0%, an output variation that increases the output instantaneously from an output more than 0% to an output less than 100% and an output variation that decreases the output instantaneously from an output less than 100% to an output more than 0%, or a plurality of output variations among these.

3. An ultrasonic cleaning apparatus, comprising:
a cleaning tank in which a cleaning liquid is stored;
a plurality of ultrasonic transducers that gives ultrasonic vibrations to an object to be cleaned immersed in the cleaning liquid within said cleaning tank;
a plurality of ultrasonic generators that applies a high-frequency output to each of said plurality of ultrasonic transducers; and
a controller that varies and controls the output of one or more ultrasonic generators among said plurality of ultrasonic generators, wherein
an ultrasonic wave oscillated from an ultrasonic transducer to which a high-frequency output is applied by said one or more ultrasonic generators is caused to interfere with an ultrasonic wave oscillated from an ultrasonic transducer to which a high-frequency output is applied by at least one ultrasonic generator among said plurality of ultrasonic generators.

4. The apparatus according to claim 3, wherein
variation of the output of said one or more ultrasonic generators is any of an output variation that increases the output continuously from an output not less than 0% to an output not more than 100%, an output variation that increases the output stepwise from an output not less than 0% to an output not more than 100%, an output variation that decreases the output continuously from an output not more than 100% to an output not less than 0%, an output variation that decreases the output stepwise from an output not more than 100% to an output not less than 0%, an output variation that increases the output instantaneously from an output more than 0% to an output less than 100% and an output variation that decreases the output instantaneously from an output less than 100% to an output more than 0%, or a plurality of output variations among these.

5. The apparatus according to claim 1, wherein said object to be cleaned is one object to be cleaned or a plurality of objects.

6. An ultrasonic cleaning method, comprising the steps of:
immersing an object to be cleaned in a cleaning liquid within a cleaning tank; and
cleaning said object to be cleaned by giving an ultrasonic vibration to said object to be cleaned by a first ultrasonic transducer and, simultaneously, giving an ultrasonic vibration to said object to be cleaned by a second ultrasonic transducer, wherein,
along with the interference of a first ultrasonic wave oscillated from said first ultrasonic transducer, with a second ultrasonic wave oscillated from said second ultrasonic transducer, a high-frequency output applied to at least one of said first and second ultrasonic transducers is varied.

7. An ultrasonic cleaning method, comprising the steps of:
immersing an object to be cleaned in a cleaning liquid within a cleaning tank; and
cleaning said object to be cleaned by giving an ultrasonic vibration to said object to be cleaned by a plurality of ultrasonic transducers, wherein,
along with the interference of an ultrasonic wave oscillated from one or more ultrasonic transducers among said plurality of ultrasonic transducers, with an ultrasonic wave oscillated from at least one ultrasonic transducer among said plurality of ultrasonic transducers, a high-frequency output applied to said one or more ultrasonic transducers is varied.

8. The apparatus according to claim 2, wherein said object to be cleaned is one object to be cleaned or a plurality of objects.

9. The apparatus according to claim 3, wherein said object to be cleaned is one object to be cleaned or a plurality of objects.

10. The apparatus according to claim 4, wherein said object to be cleaned is one object to be cleaned or a plurality of objects.
